(19) United States
(12) Patent Application Publication
(10) Pub. No.: US 2014/0175089 A1
(43) Pub. Date: Jun. 26, 2014

(54) COLLAPSIBLE SHIPPING CONTAINER AND PROCEDURE TO DISASSEMBLE AND ASSEMBLE SAID CONTAINER

(71) Applicant: Daniel Isaac SZULMAN, Buenos Aires (AR)

(72) Inventor: Daniel Isaac SZULMAN, Buenos Aires (AR)

(21) Appl. No.: 13/886,538

(22) Filed: May 3, 2013

(30) Foreign Application Priority Data
Dec. 26, 2012 (AR) 20120104995

(51) Int. Cl. B65D 88/52; B23P 11/00; B65D 88/10

(52) U.S. Cl. CPC B65D 88/528; B65D 88/10; B23P 11/00
USPC 220/1.5; 220/4.33; 29/426.5

(57) ABSTRACT

A container includes a typically upright structure that may be disassembled by the release of locks. The locks include a system of upper forced wedging longitudinal locks that connect to adjacent edges of the top walls and side walls of the container. Forced wedging cuneiform side locks connect the minor or head side walls to the major top walls and side walls. A method of assembly/disassembly includes a series of stages by which the locks are removed, the top wall is removed, the container's head walls are disassembled, the side walls are lowered and all these walls are overlapped on the base wall until forming a flat structure. This flat structure may be mounted again in the opposite manner, until the container is upright and forms the load housing again.

### TECHNICAL FIELD

Certain embodiments of the present invention relate, for example, to transport and devices for transport and storage.

Embodiments of the present invention include a collapsible shipping container suitable for automatic disassembly and assembly. The collapsible shipping contain has a structure that when upright can be disassembled turning it into a flat structure with overlapping walls, and that can be easily reassembled, thanks to a connection system and forced wedging locks.

Embodiments of the present invention include a method of disassembly and assembly in which a stage sequence easily enables disassembly and assembly of a container provided with the above mentioned connection system and locks.

### BACKGROUND

Imbalances in world trade—in particular, among countries that are mainly exporters, and those countries that are mainly importers—cause inefficiencies in shipping. For example, containers that are originally loaded when transported to a country often come back empty.

Empty containers occupy space within the means for transport, and thus shipping these empty containers incurs high costs.

Conventional load containers have a fixed structure that cannot be disassembled temporarily. To address the inconvenience of shipping empty containers, containers are designed with structures that are detachable and/or foldable.

Such is the case of the container disclosed by the patent document AR 065037 A1, by the same inventor of the present invention.

Other containers include those disclosed by the patent documents U.S. Pat. No. 3,765,556 and U.S. Pat. No. 5,190,179, whose foldable structure is mainly based on some longitudinally foldable side walls. This type of structure has a large manufacturing cost, and, in addition, they are complex and prone to failure and hindrances that prevent their adequate folding or deployment.

Patent documents JP 1,153,480 and JP 63,203,580 show the use of wedges to connect mainly the side walls and the base. In addition, patent document JP 63,307,087 discloses the use of wedges that also connect the side walls with the top wall. Wedges are also used at the container corners.

On the other hand, patent document U.S. Pat. No. 3,327,882 discloses a plastic container with lengthened wedges which are fixed on the lid or top wall, which work associated to an inner protruding portion of said lid, and that fit into some slots formed on the side walls. The same system is used to connect the side walls with the base.

U.S. Pat. No. 4,069,938 discloses a system based on a top wall with an inner closure wall that have some wedge-shaped members, but which act as guides.

### DISCLOSURE

Embodiments of the present invention include a collapsible container (either by disassembly or folding) that may be easily disassembled, shipped and assembled again at the place of destination.

Embodiments of the present invention also include a container that may be disassembled easily, with low cost and safety, avoiding accidents, and/or preventing the different components of its structure from suffering blows or deterioration.

Embodiments of the present invention also include a container able to be disassembled or assembled using an automatic machine or device, without direct intervention of human operators. In some embodiments, the container is such that an appropriate automatic device, with a sequence of simple and quick operations, may disassemble the container and arrange the container conveniently folded and reduced to its minimum volume.

In certain embodiments, the characteristics of the side walls, base and top wall enable the structure to remain orderly disassembled, so that the assembly process may also be carried out sequentially, automatically, quickly and simply. In this regard, in an embodiment, the longitudinal locks should not be removed during the disassembly and kept until the time of assembly, as they remain connected to the top wall, and consequently, into the disassembled container.

An advantage of certain embodiments of the present invention is that the container can do without axes, bushings and similar rotary devices. This provides the following benefits:
lower weight,
simplified assembly,
reduced cost; and
avoidance of blows that, in other containers, hinder or prevent the side walls from rotating, because the precision of the clearance between the axe and the bushing throughout the container is affected.

Definitively, axes and bushes are overlooked, not only in the connection between the top wall and the side walls, but also between the side walls and the base, which substantially reduces the chance of failure.

Another advantage of certain embodiments is that the presence of the longitudinal locks enables a reduction in the amount of connections between the top wall and the side walls. These longitudinal locks may, for example, have different sizes, with the possibility to use only a few or even only one lock per each longitudinal edge. The smaller quantity of locks avoids rotary systems or with numerous locks, or small connections.

A larger amount of locks or connections increases the chance that a failure will prevent the top wall from being disassembled, or that the top wall does not close perfectly when assembled. In addition, a large amount of locks increases complexity, cost and the probability of failure.

Therefore, a further advantage of certain embodiments of the present container is the presence of a system of longitudinal locks, which are simply pushed, either for their wedging or removal.

Another advantage of certain embodiments is the provision of the possibility to use side locks that may be removed using magnetic devices (either electromagnets or permanent magnet). Thus, it is possible to manage without systems with rotary pieces or with removal locks that require a running gear, rotation and reverse blocking, to remove the locks. In this manner, failures originating from the presence of slurries, oxides and other elements that, during maritime and terrestrial shipping of the containers, cause obstructions in any opening or exposed cavity can be avoided. Additionally, a reduction of requirements for an automatic assembly and disassembly machine or device can be realized.

A further advantage of certain embodiments is the possibility of using in the different wedging pieces, a system of elastic positional locks which supplement the other systems. In this manner, a system of corner wedges with rotary system and lock is not required. This system also prevents failure and reduces the requirements for an automatic assembly and disassembly machine or device.

### BRIEF DESCRIPTION OF THE DRAWINGS

FIG. 1 is a perspective view of the present container partially disassembled, with eight details referred to the upper lock members of the top wall, the joint between the base wall and the first side wall, the upper inlet of the first head wall, the lower inlet of the first head wall, the lower lock members of the base wall, the joint and the lowering compensator of the second side wall, the upper longitudinal edge of the side walls and the forced wedging locks. It also includes a detail of a partial cross section of the assembled container, wherein the cuneiform member can be observed, already wedged in the lock position.

FIG. 2 is an anterior perspective view of a lengthened cuneiform member out of its position in the forced wedging opening or access, in order to appreciate its components.

FIG. 3 is a posterior perspective view of the lengthened cuneiform member of FIG. 2, which is also shown out of the forced wedging opening or access.

FIG. 4 comprises the drawings A and B, where:

Drawing A is a cross section which shows the cuneiform member positioned and with the wedge removed in the opening of the forced wedging; and

Drawing B is another cross section where the cuneiform member is shown, already wedged in the connection and lock position.

FIG. 5 comprises drawings A, B and C, where:

Drawing A is a longitudinal section of a longitudinal edge of the top wall, into which the insertion pieces may be observed;

Drawing B is another longitudinal section of the longitudinal edge of the top wall, into which the insertion pieces and a wedged cuneiform member may be observed; and

Drawing C is an upper and top view, of the longitudinal edge of the top wall with the wedged cuneiform member.

FIG. 6 comprises drawings A, B and C, where:

Drawing A is an upper, top view of a simple insertion piece;

Drawing B is an upper, top view of a double insertion piece; and

Drawing C is a cross section of the insertion pieces.

FIG. 7 comprises drawings A, B and C, where:

Drawing A is a longitudinal cross section of a longitudinal edge of the top wall into which a set of insertion pieces may be observed;

Drawing B is a longitudinal section of a longitudinal edge of the top wall into which two one-piece insertion pieces may be observed; and

Drawing C is a longitudinal section of a longitudinal edge of the top wall into which an insertion piece with more than one forced wedging passage may be observed.

FIG. 8 comprises drawings A, B and C, where:

Drawing A is an upper, top view of a longitudinal edge of the top wall with several longitudinal locks;

Drawing B is an upper, top view of a longitudinal edge of the top wall with two longitudinal locks; and

Drawing C is an upper, top view of a longitudinal edge of the top wall, with only one longitudinal lock which extends throughout the edge.

Drawing 9 is a perspective view of the present container entirely mounted with its upright structure and indicating the removal of the side locks.

FIG. 10 comprises drawings A, B, C, D and E, where:

Drawing A is a perspective view of an upper lock that connects the top wall to a side wall;

Drawing B is a front elevated view, of the lock of drawing A;

Drawing C is a side elevated view, of the lock of drawing A;

Drawing D is a back, elevated view, of the lock of drawing A; and

Drawing E is a cross section of the lock of drawing A, where the elastic lock may be observed.

FIG. 11 comprises drawings A, B, C, D and E, where:

Drawing A, a perspective view of an upper lock which connects the top wall with a side wall, in an embodiment with side fixing opening;

Drawing B is a front, elevated view of the lock of drawing A;

Drawing C is a side, elevated view of the lock of drawing A;

Drawing D is a back, elevated view of the lock of drawing A; and

Drawing E is a cross section view of the lock of drawing A, where the detail of the fixing opening may be observed.

FIG. 12 is a perspective view of the present container with its top wall and its minor side walls disassembled.

FIG. 13 is a perspective view of the present container with the second head wall and the top wall disassembled. Two details of the connections between head and side wall are included: a first detail in perspective, of the side connections in the second head wall, and a second detail, in a top, elevated view, of the connection between the first side wall and the first head wall.

FIG. 14 is a perspective view of the container where the top wall and the head walls may be seen disassembled, together with the first major side wall disassembled on the base wall.

FIG. 15 is a perspective view of the container with its two minor side walls disassembled, and with the minor side walls or head walls and top wall, prepared to be overlapped.

FIG. 16 comprises drawings A, B and C, where:

Drawing A is a side, elevated view, which shows the articulation between a major side wall and the base wall; the latter standing upright;

Drawing B is a side, elevated view, which shows the articulation between a major side wall and the base wall; the latter being disassembled or folded; and

Drawing C is a perspective view of a detail of the articulation.

FIG. 17 is a perspective view of the container with its two major side walls disassembled, and indicating the movement of disassembly of the minor side walls.

FIG. 18 is a perspective view of the container with its two major side walls disassembled, and with the head walls overlapped. A detail of the travel stop of the head wall is included.

FIG. 19 is a perspective view of the fully assembled container, forming a flat structure.

FIG. 20 is a front, elevated view of the fully disassembled container, with the major side walls disassembled on the base.

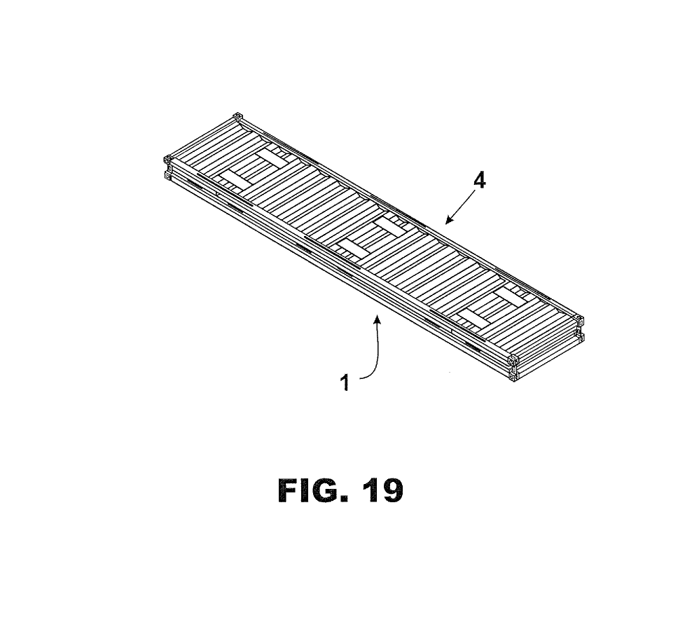

FIG. 21 is a front, elevated view of the fully disassembled container, forming a flat structure with all the walls overlapped.

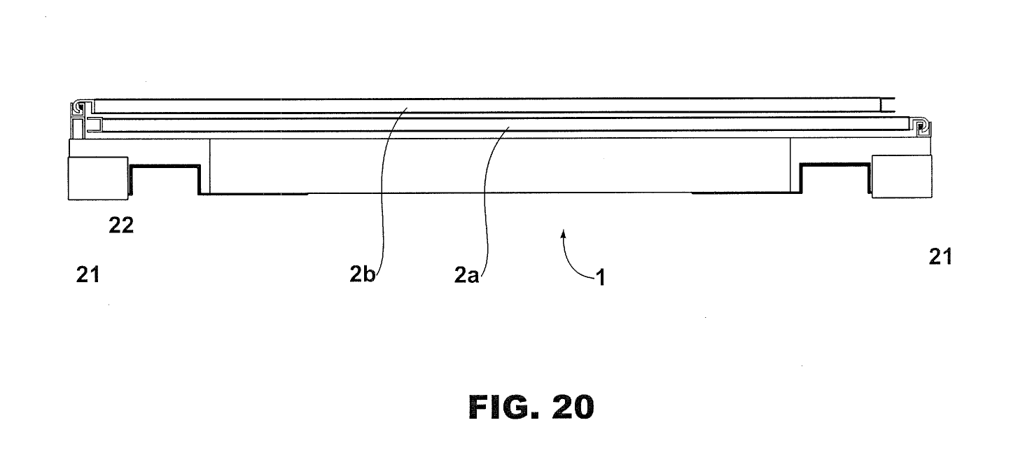

FIG. 22 is a perspective view of the detail which shows the relation between top wall and the base, when the structure is completely disassembled or folded.

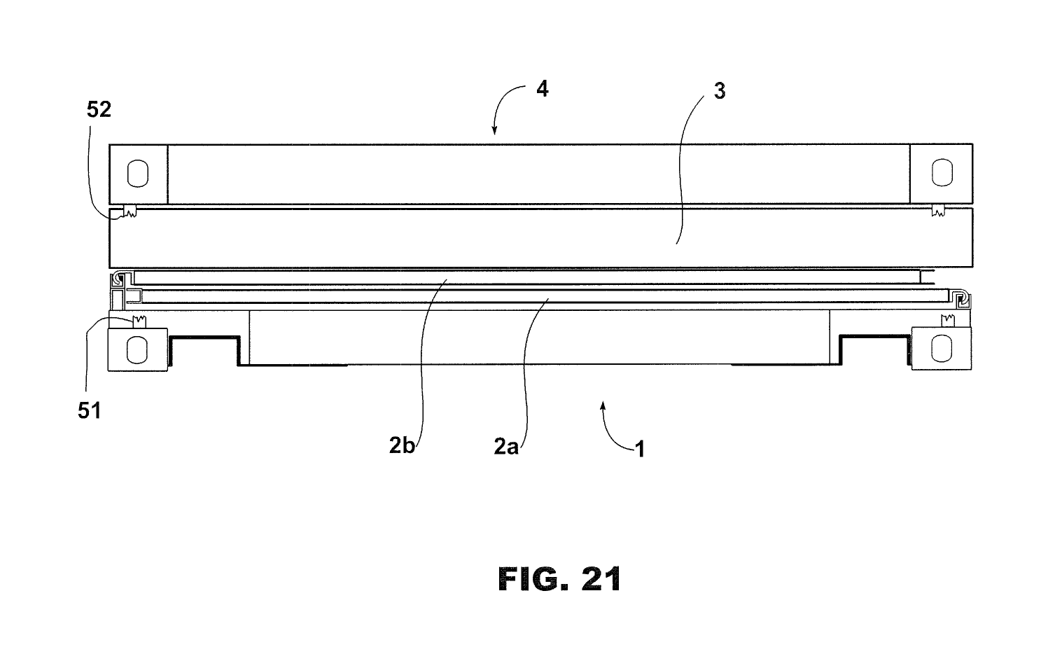

FIG. 23 comprises drawings A and B, where:

Drawing A is a detail in front, elevated view, where the misaligned lock members may be seen, and opposite to their respective inlets, provided by the head walls, and

Drawing B is a detail in front, elevated view, where it may be observed how the misalignment between the locking members enables that they remain by each other, and ready for the placement of a forced wedging lock.

FIG. 24 is a partial perspective view of the top wall wherein a hanging support can be observed.

FIG. 25 is a partial longitudinal section of the top wall where the wave passage of the plate is shown.

In the different figures, the same numbers and/or reference letters indicate equal or corresponding parts.

### LISTING OF REFERENCE CHARACTERS

(1) Base wall of the container.
(2) Major side walls of the container
(2a) First major side wall.
(2b) Second major side wall.
(20) Upper longitudinal edges of the major side walls (2).
(20a) Forced wedge-removed opening or access.
(20b) Lower wall of the longitudinal edge (20).
(20c) Wedging limit.
(21) Lower longitudinal edges of the major side walls (2).
(22) Articulation bends [that connect the major side walls (2) with the base wall (1)]
(22a) Bend end.
(23) Articulation profile.
(24) Articulation casing.
(25) Articulation opening.
(26) Lowering compensator.
(3) Minor side or head walls of the container.
(3a) First minor side or head wall.
(3b) Second minor side or head wall [door].
(30) First columns of the minor side walls (3).
(31) Second columns of the minor side walls (3).
(32) Lower inlets [for coupling with the lower connection members (51)].
(33) Upper inlets [for coupling with the upper connection members (52)].
(34) Lock openings [for insertion of the forced wedging locks
(6)].
(4) End or top wall of the container.
(40) Longitudinal edges [of the top wall (4)].
(41) Forced wedging opening or access.
(42) Retention lock.
(45) Hanging passage.
(46) Hanging supports
(47) Cross section or head edges of the top wall (4).
(5) Structural corners.
(50) Upper opening of the structural corner (5).
(51) Members of the lower locks [they project from the base wall
(1)]
(51a) First lock passage of the lower lock member (51).
(52) Members of the upper locks [they project from the top wall (4)].
(52a) Second lock passage of the lower lock member (52).
(53) Travel stop.
(6) Forced wedging side locks.
(60) Lock body (6).
(61) Lock anterior wall (6).
(62) Forced wedging walls.
(63) Lock back wall (6).
(64) Side positional elastic locks.
(65) Side fixing opening.
(66) Side lock guide.
(67) Side lock groove.
(7) Upper longitudinal locks [to connect the minor side walls (2) with the top wall (4)].
(70) Lengthened cuneiform member of the longitudinal lock (7).
(71) Upper wall.
(72) Wedging walls.
(72a) Guide stop.
(73) Wedge-removing end.
(73a) Forced wedging stop.
(74) Upper elastic positional locks.
(75) Upper insertion piece.
(76) Lower insertion piece.
(77) Forced wedging passage.
(78) Positional recesses.
(8) Side connections [they connect the major side walls (2) to the minor or head side walls (3)].
(81) First side connections [they project from the major side walls (2)].
(82) Second side connections [they project from the minor or head side walls (3)].
(81a)(82a Edges for invitation to wedging in the first (81) and second) (82) side connections.
(101) Upper waterproof insulator [between the upper longitudinal edges (40) (20)].
(100) Lower waterproof insulator [into the casing (24)].
(110) Wave passage of the plate which constitutes the side walls (2) (3) and the top wall (4).
(111) Recessing half-wave.
(112) Projecting half-wave.

### DETAILED DESCRIPTION OF EMBODIMENTS

Embodiments of the present invention include a collapsible shipping container whose structure, which is usually upright, may be disassembled by the release of a system of locks which comprises: upper longitudinal locks (7) of forced wedging, which connect the adjacent edges (40)(20) of the top (4) and side walls (2)(3); and forced wedging side cuneiform locks (6) that connect the minor or head side walls (3) with the top walls (4) and major side walls (2). Embodiments of the present invention also include a method in which said locks are removed (6)(7), the top wall is removed (4), its head walls are disassembled (3), the major side walls are lowered (2) and all these walls are overlapped (2)(3)(4) on the base wall (1) until forming a flat structure. This flat structure may be assembled again in the inverse manner, until the structure stands upright and the container again shapes the load housing.

In embodiments of the present invention, the container comprises an upright structure that, either collapsible or foldable, may be disassembled until turning it into a flat structure and vice versa. This capability of assembly and disassembly is due to the particular constitution and relation among the walls (1) (2) (3) (4).

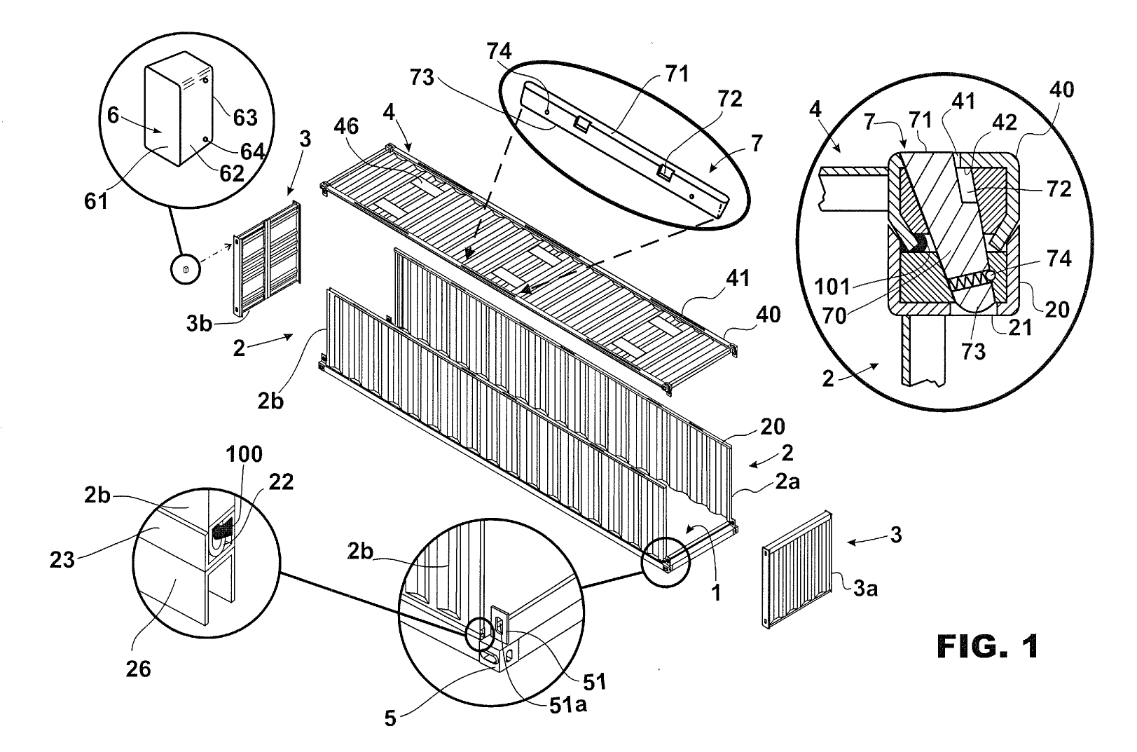

Referring to FIG. 1, the walls (1)(2)(3)(4) comprise a base wall (1), two major side walls (2), two minor or head side walls (3) and a top wall (4), inside which is a for a load to be shipped. These walls (1) (2) (3) (4) may be structured by profiles and profiled plates.

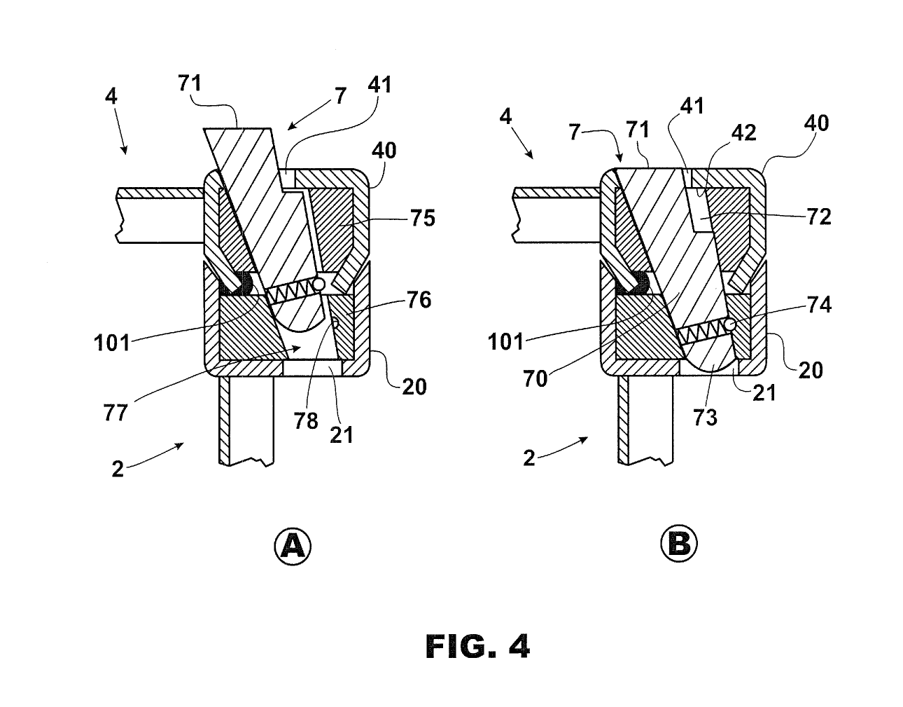

The base wall (1) may show different building variations, including the arrangement of floors on the base wall (1). In the embodiment shown in FIG. 4, the base wall (1) has been provided with articulation profiles (23) that connect the base wall (1) to the articulation bends (22) of the side walls (2) of the container. The articulation profiles 23 enable the side walls (2) to lower or stand up with respect to the base wall (1).

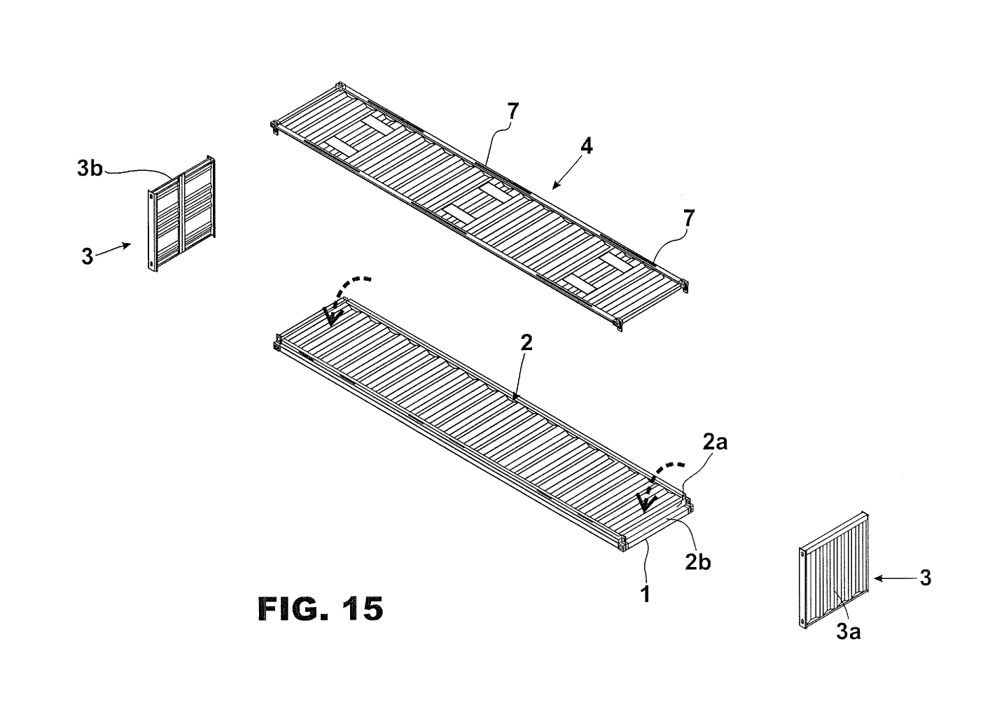

FIG. 16 shows more detail of the articulation bend (22) and articulation profiles (23). Referring to FIGS. 1 and 16, an articulation bend (22) is disposed in the lower longitudinal edges (21) of the side walls (2). This articulation bend (22) operates into an articulation profile (23) which is fixed to the base wall (1). The articulation bend (22) enters the profile (23) through an articulation opening (25). Inside the articulation profile (23), there is a casing (24), which houses a lower waterproof insulator (100) with which the bend end (22a) contacts when the side wall (2) is upright.

The side walls (2) comprise a first (2a) and a second (2b) side wall. The first side wall (2a) connects to the base wall (1) using an articulation bend (22), which allows the first side wall (2a) to be lowered or placed upright relative to the base wall (1). In addition, the second side wall (2b) also connects to the base wall (1) using a corresponding articulation bend (22), although in this case, the second side wall (2b) has a lowering compensator (26) which elevates the second side wall (2b) over the first side wall (2a).

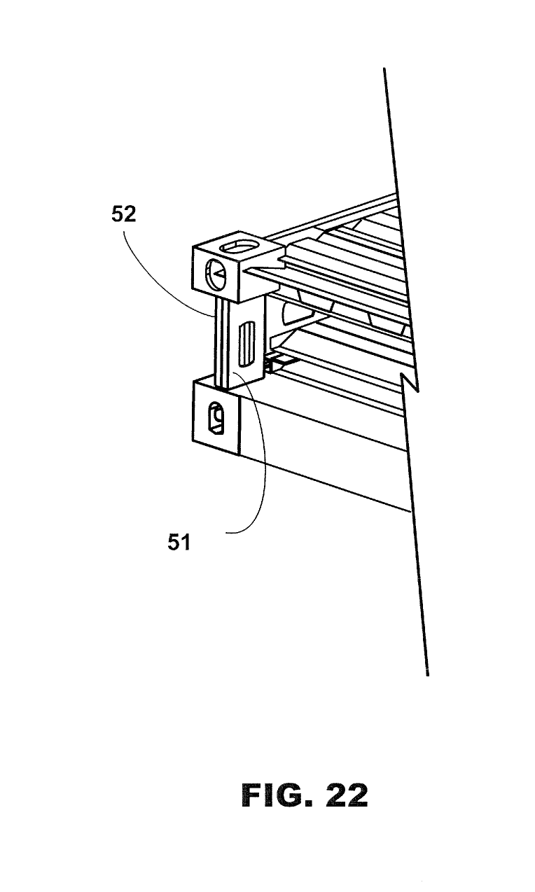

Turning to FIGS. 1 and 23, the base wall (1) comprises structural corners (5) from which lower lock members (51) project. The lower lock members (51) insert into lower inlets (32) belonging to the columns (30) (31) of the head walls (3). With this arrangement, first lock passages (51a) of the lower lock members (51) remain aligned or opposite to lock openings (34), so that they form a forced wedging passage where forced wedging locks (6) are housed.

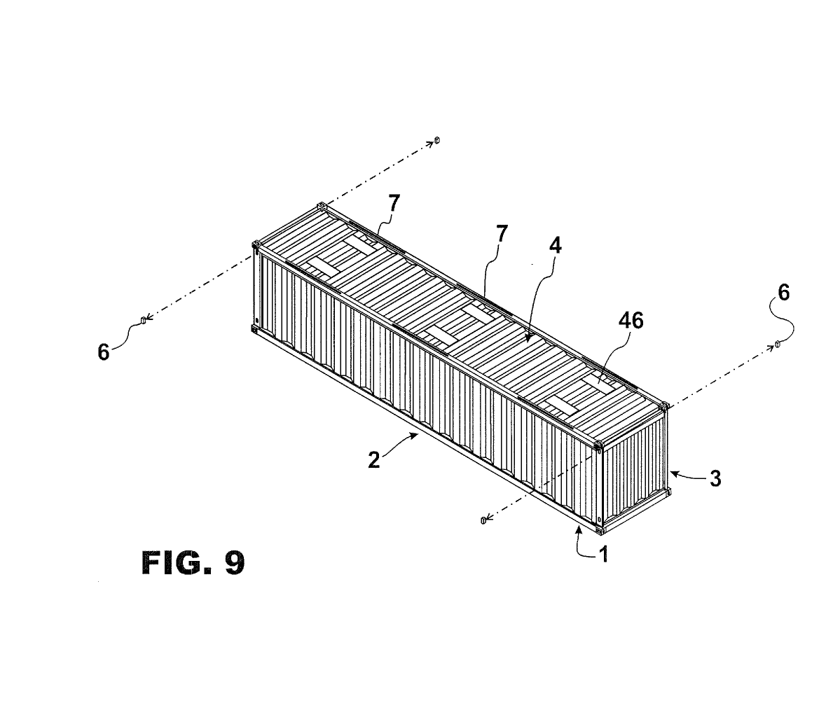

Referring to FIGS. 1 and 10, in an embodiment, these forced wedging side locks (6) may be cuneiform or truncated-shaped—for instance, truncated cones or truncated pyramids—whose body is defined by an anterior or major wall (61), side walls of forced wedging (62) and a back or minor wall (63). The side walls (62) have some side positional elastic locks (64) which act in the lock passages (51a) (52a) of the lock members (51) (52).

The side positional elastic locks (64) comprise, for example, projecting members—for instance balls—that, under the influence of elastic means, project themselves out of their splits and fit into positional recesses provided by the forced wedging walls to which they are applied (51a)(52a).

In an embodiment, the forced wedging side locks (6) comprise a material susceptible to magnetic induction, allowing them to be removed using magnetic devices, based on electromagnets, as well as on permanent magnets.

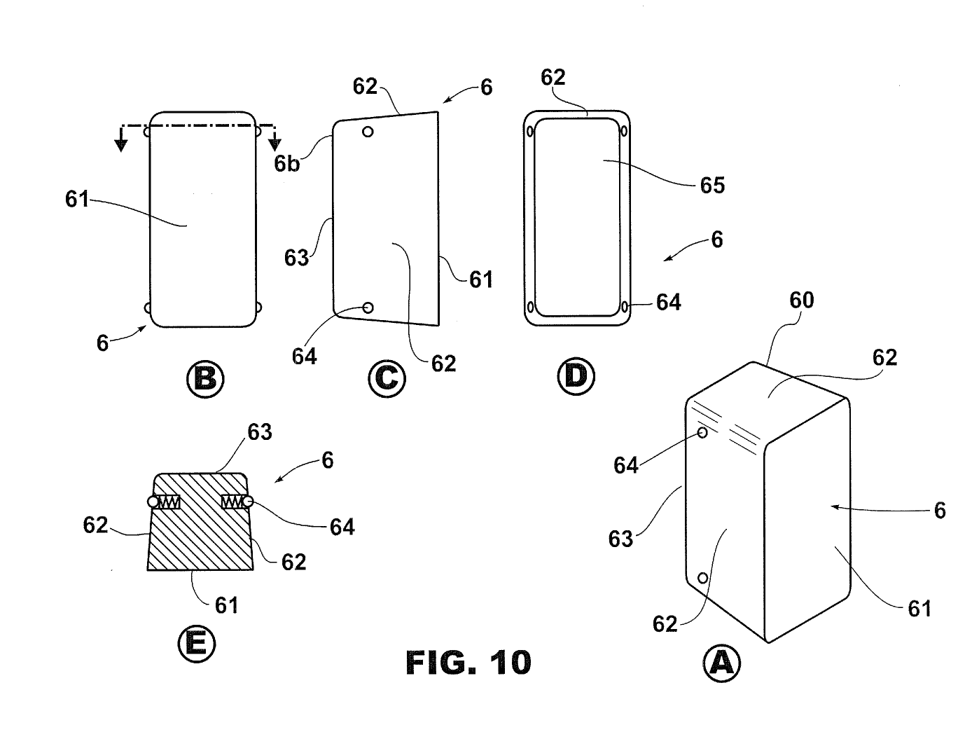

Referring to FIGS. 10 and 11, in an embodiment, the forced wedging side locks (6) may have a fixing opening (65) on its anterior wall (61). This fixing opening (65) presents a side lock guide (66), which is in communication with a side lock groove (67). The fixing opening 65, side lock guide (66) and side lock groove (67) enable the entrance of an operative instrument that may enter and turn into the groove (66) to enable the removal or extraction of the forced wedging locks (6).

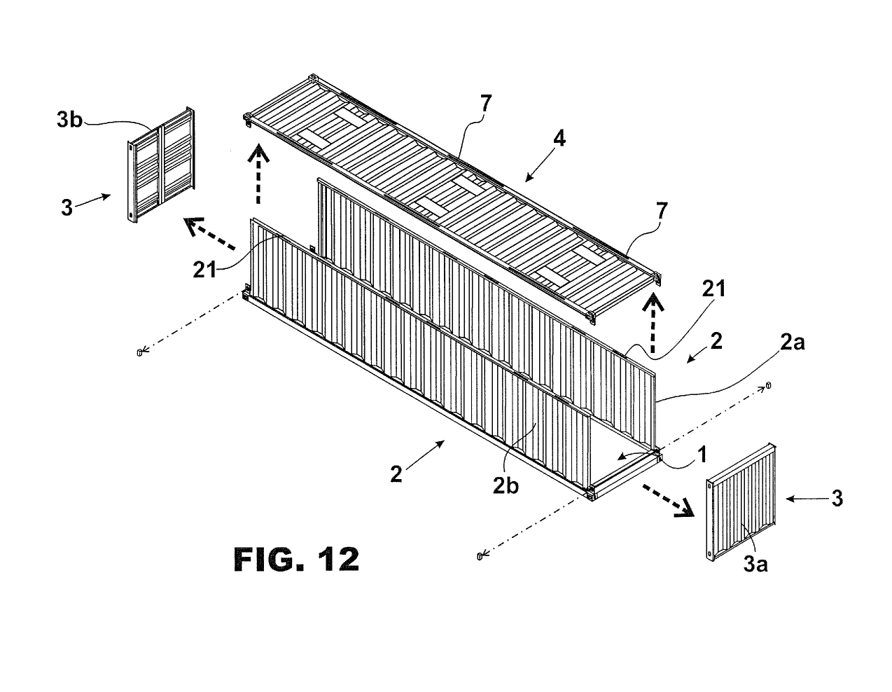

Referring again to FIG. 1, the minor or head side walls (3) comprise a first head wall (3a) and a second head wall (3b). The second (3b) may have an opening, such as a door with one or more leaves and their corresponding closure system. In the present embodiment, the head walls (3) are described as having side columns (30) (31) (see FIGS. 13 and 23).

Referring to FIGS. 1 and 13, the side columns (30) (31), as well as the adjacent edges of the side walls (2), have side connections (8) which connect the side walls (2) to the head walls (3). In one embodiment, they may be side guide connections (8) integrated by first side connections (81) that project from the side walls (2) and second side connections (82) which project from the head walls (3). Both connections (81) (82) have their corresponding edges inviting to the wedging (81a) (82a) which facilitates their connection.

Referring to FIGS. 13 and 23, besides the lower inlets (32) already described, in their upper end the columns (30) (31) have upper inlets (33) for receiving the upper lock members (52) which project from the top wall (4) [for instance, from their structural corners (5)]. With this arrangement, the second lock passages (52a) of the upper lock members (52) remain aligned or opposite to the upper lock openings (34), thus forming forced wedging passages where forced wedging locks (6) are housed.

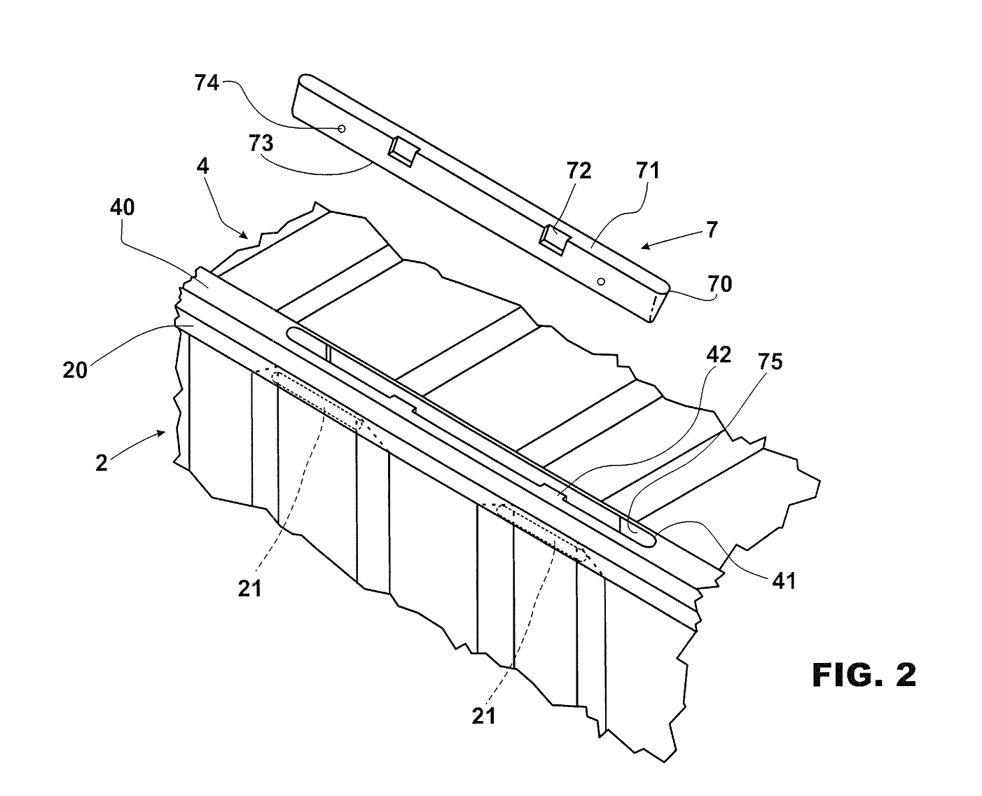

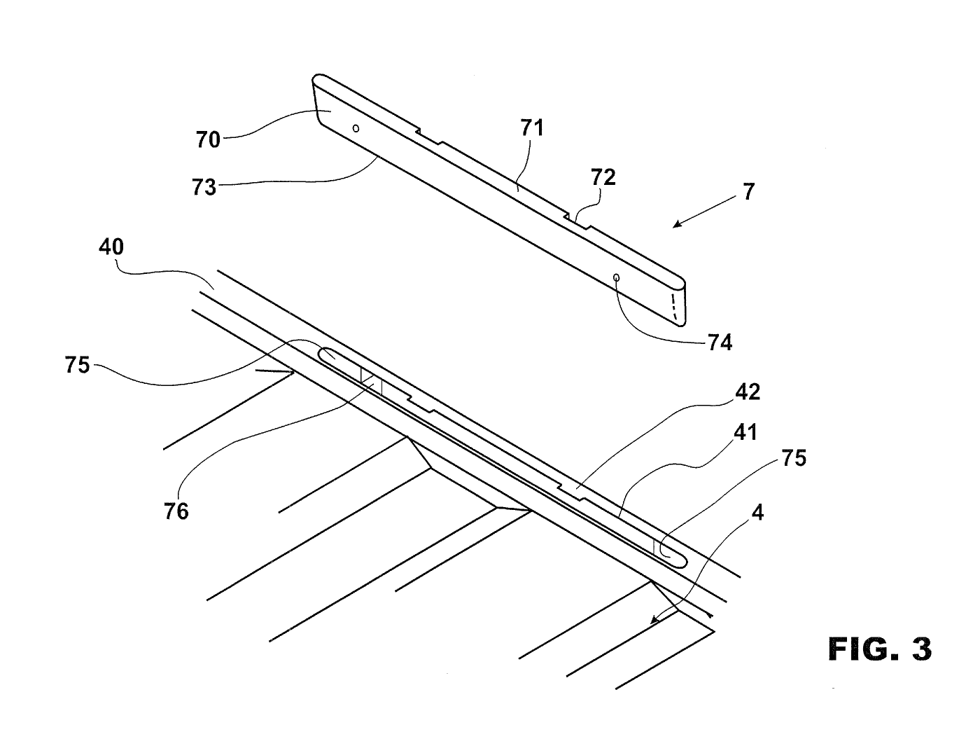

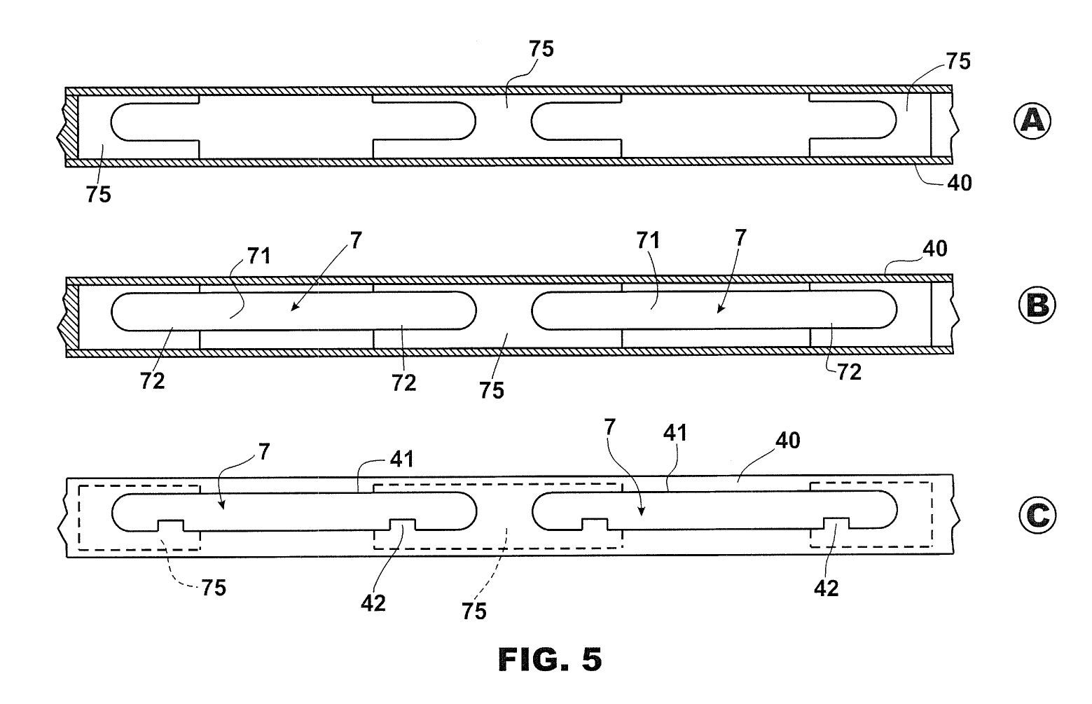

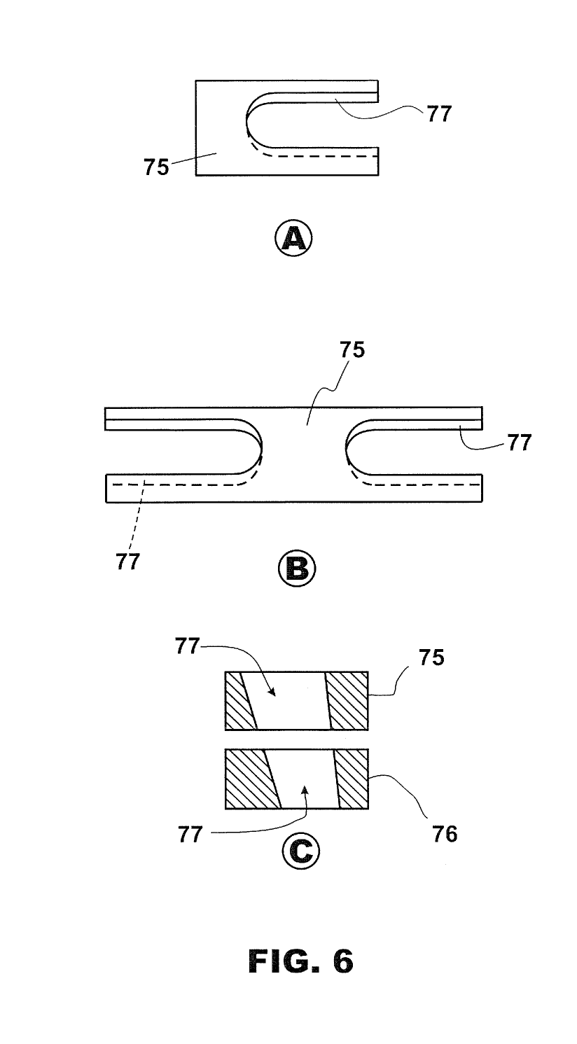

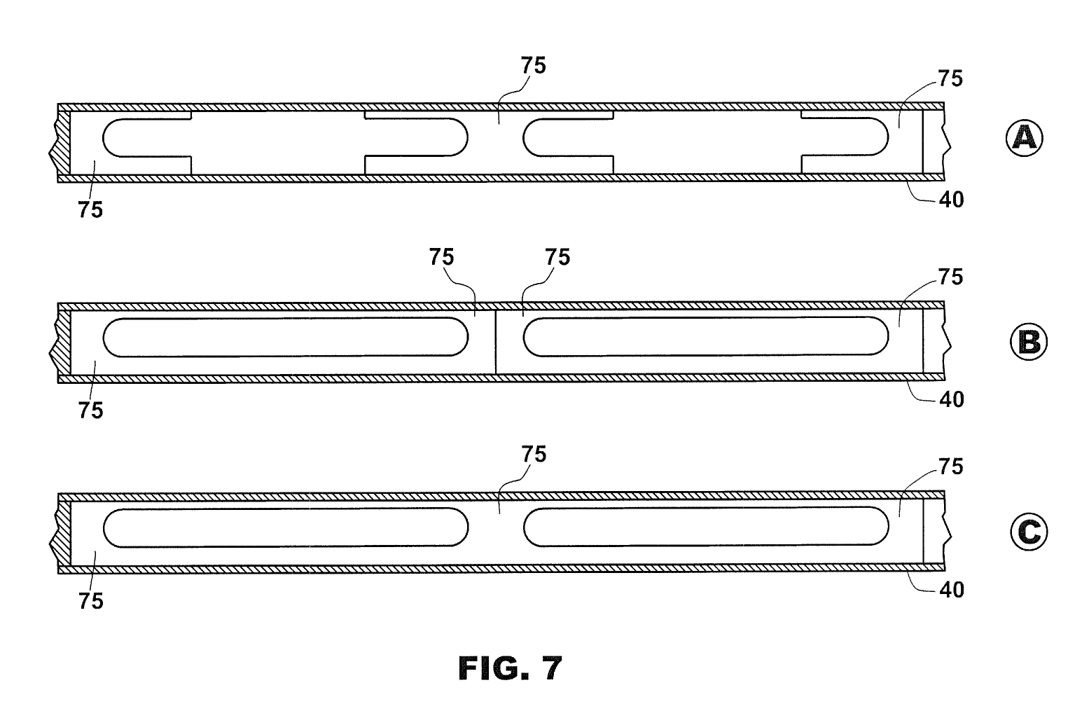

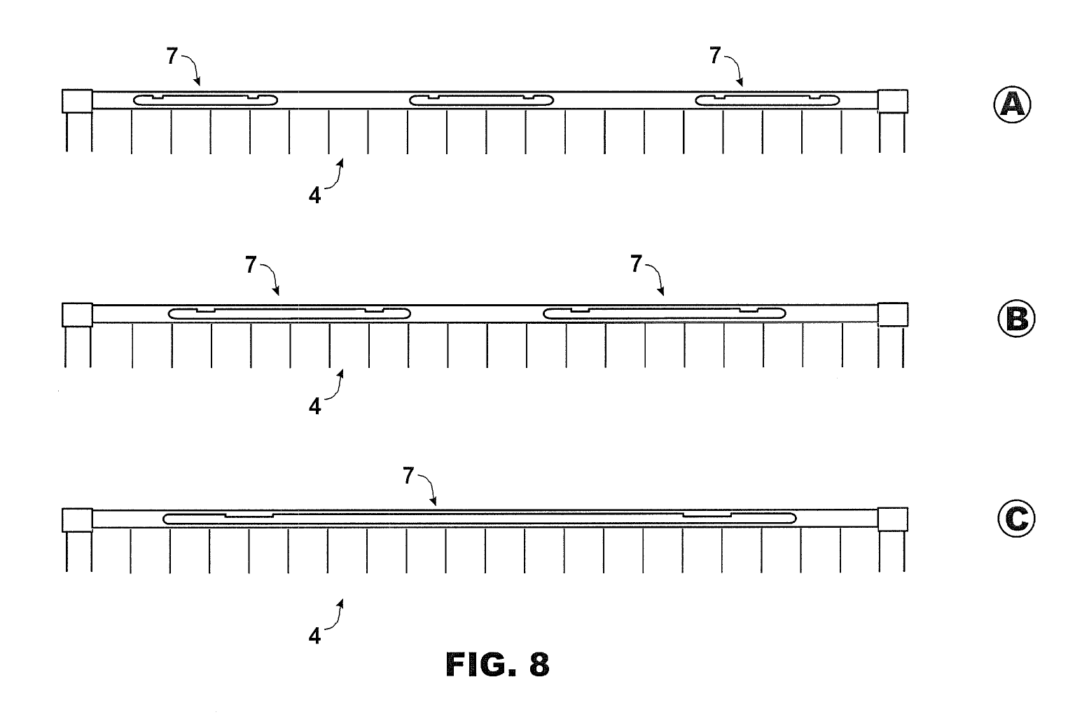

Referring to FIGS. 1-8, the system of upper longitudinal locks (7) connects the adjacent edges (40) (20) of the top wall (4) and the side walls (2).

These upper longitudinal locks (7) comprise cuneiform, lengthened members (70)—in the longitudinal sense of said walls (40) (20)—which fit into forced wedging passages (77) defined by insertion pieces (75) (76).

The cuneiform members (70) form an upper wall (71), from which side wedging walls (72) extend, until ending in a wedge-removing end (73).

In an embodiment, the forced wedging passages (77) start in an existing wedging opening (41) in the profiles that form the longitudinal edges (40) of the top wall (4). The upper insertion pieces (75) are placed into the longitudinal edge (40) so as to form the first portion of the wedging passages (77).

The second portion of the wedging passages (77) is formed by the lower insertion pieces (76), which are placed into the profiles that form the upper longitudinal edges (20) of the side walls (2). The wedging passages (77) have wedging openings (20a) existing in the lower wall (20b) of the longitudinal edges (20).

In an embodiment, the insertion pieces (75) (76) may be one-piece or may form a set. In the case of the one-piece insertion piece (75) (76), a single piece may define a single forced wedging passage (77). Furthermore, in an embodiment a single insertion piece (75) (76) provided with one or more forced wedging passages (77) may be used for the adjacent edges (20) (40).

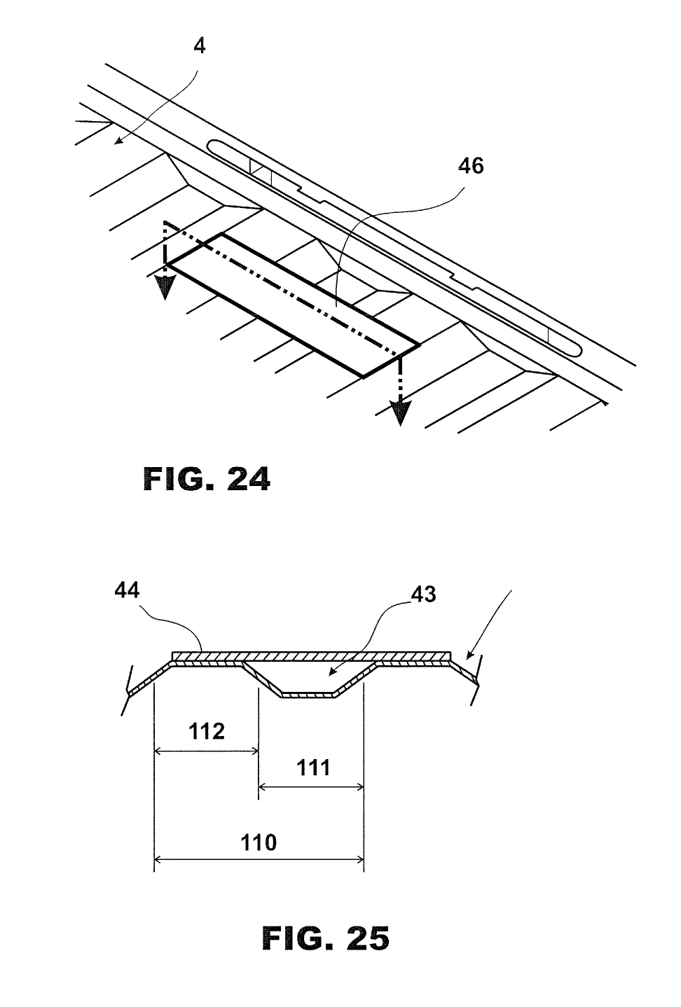

In another embodiment, there may be one or more of the wedge-removing openings (20a) per each wedging passage (77). This is due to the fact that the forced wedging passage (77) may be longer than the wave passage (110) of the plate that forms the side walls (2) (3) (See, e.g., FIG. 25). Therefore, the wedge-removing openings (20a) must coincide with the recessing half-wave (111) of the passage (110), so that they remain exposed and enable the introduction of wedge-removing means of the cuneiform members (70).

In an embodiment, on one of the wedging walls (72) of the cuneiform member (70), there is a guide stop (72a) in which a retention lock (42) fits. The guide stop (72a) is situated in the edge of the opening or the wedging access (41). This arrangement keeps the cuneiform member (70) in the wedging passage (77), either if the cuneiform member (70) is wedged or wedge-removed, because the cuneiform member (70) is retained, enabling its wedging and wedging-removal travel or run in the insertion pieces (75)(76).

In an embodiment, the longitudinal locks comprise upper elastic positional locks (74). The upper elastic positional locks (74) fit into positional recessing guides (78) provided in the walls of the insertion pieces (75)(76) within the wedging passage (77). The upper elastic positional locks (74) aid in ensuring the forced wedging of the cuneiform member (70).

In an embodiment, when taking into account the functions of the system of upper longitudinal locks (7), the forced wedging passage (77) will have an inclination that is such that the wedge-removing openings (20a) remain outside or in the outer part of the side walls(2).

In an embodiment, upper longitudinal waterproof insulators (101) are arranged between the upper longitudinal edges (40) (20) in a location that is between the upper longitudinal locks (7) and the container housing. The longitudinal waterproof insulators (101) may create a seal and ensure the tightness of the upper part of the container.

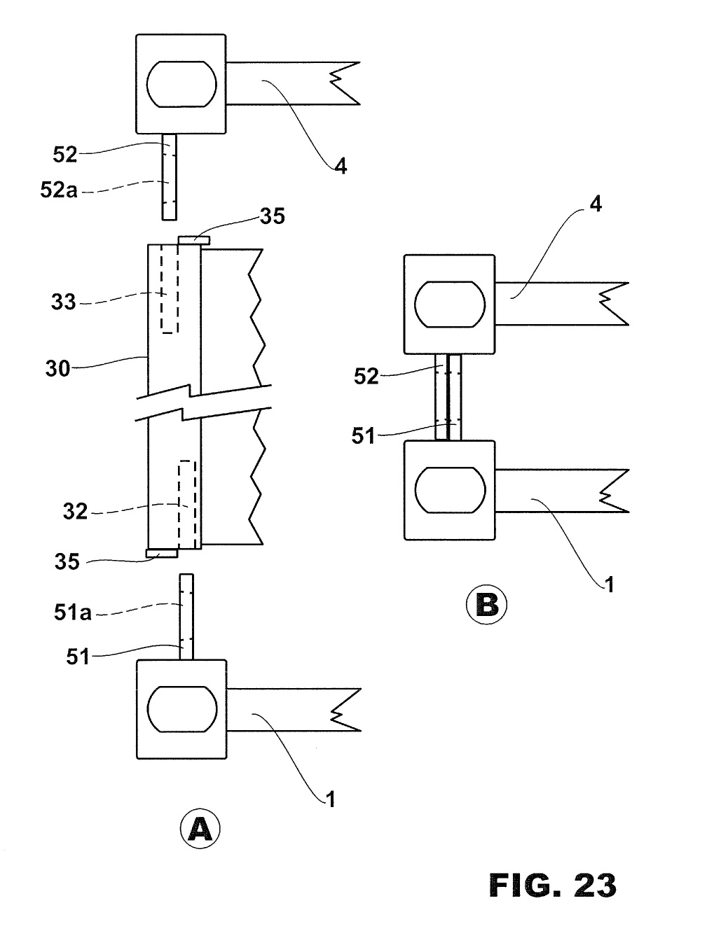

Referring to FIGS. 24 and 25, to facilitate the container assembly and disassembly maneuvers, the top wall (4) may be provided with hanging supports (46), beneath which, some hanging passages (45) enable engagement or insertion of different lifting device means.

The distribution of these hanging supports (46) along the top wall (4) enables to avoid its deformation during the maneuvers.

In case the top wall (4) is mainly structured in profiled plates, advantage is taken from this condition, by fixing the hanging support (46) in a bridge like manner, between two adjacent projecting profiles (43) (See FIG. 24), and so, the intermediate recessing profile (44) defines the hanging passage (45).

With the container assembled and in an upright state, the removal of the upper longitudinal locks (7) [that connect the top wall (4) with the side walls (2) (3)] and the removal of the side locks (6) [which connect the top wall (4) with the columns (30) (31) of the minor side or head walls (3)] enables the top wall (4) to be lifted off the container by, for example, an appropriate device. For this operation, the hanging supports (46) are available, as well as the structural corners (5) that provide some upper openings (50) suitable for this purpose.

In an embodiment, the removal of the forced wedging upper longitudinal locks (7) that connect the adjacent longitudinal edges (40) (20), is made through the wedge-removing openings (21), which enables to disconnect the top wall (4) from the side walls (2) (3).

Further, in an embodiment, the removal of the forced wedging side locks (6) that connect the lower part of the columns (30) (31) with the lower lock members (51) of the base wall (1), leaves the head walls (3) in condition to be detached from the side walls (2).

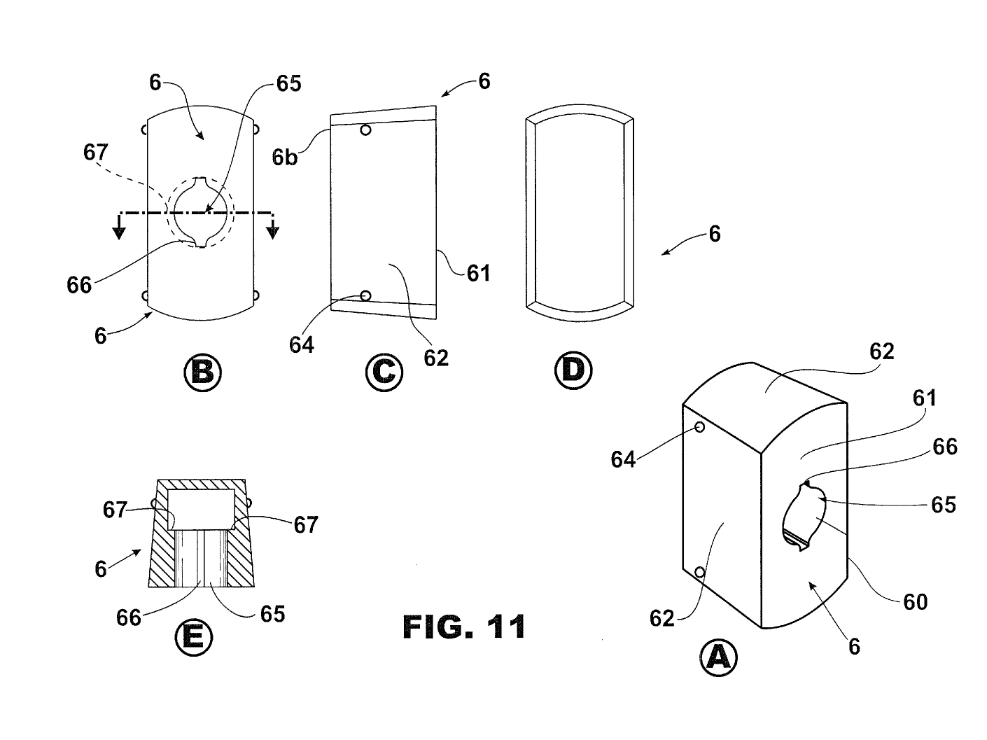

For this, the side connections (8) must be disconnected. In the present embodiment, as they are guide locks, disconnection is achieved by raising the above mentioned head walls (3) and moving them far from the base wall (1) (See FIGS. 12 and 13).

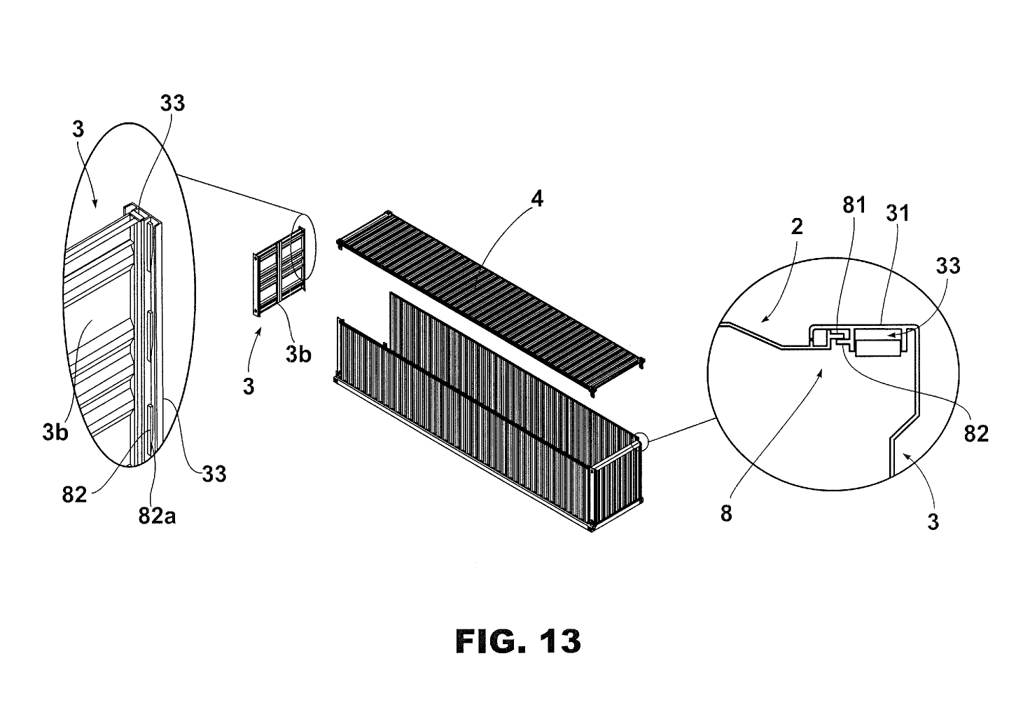

With the structure in these conditions, the first side wall (2a) may be lowered until it overlaps the base wall (1). This is possible because the articulation bend (22) of the first side wall (2a) turns within the articulation profile (23) (See FIGS. 14 and 16).

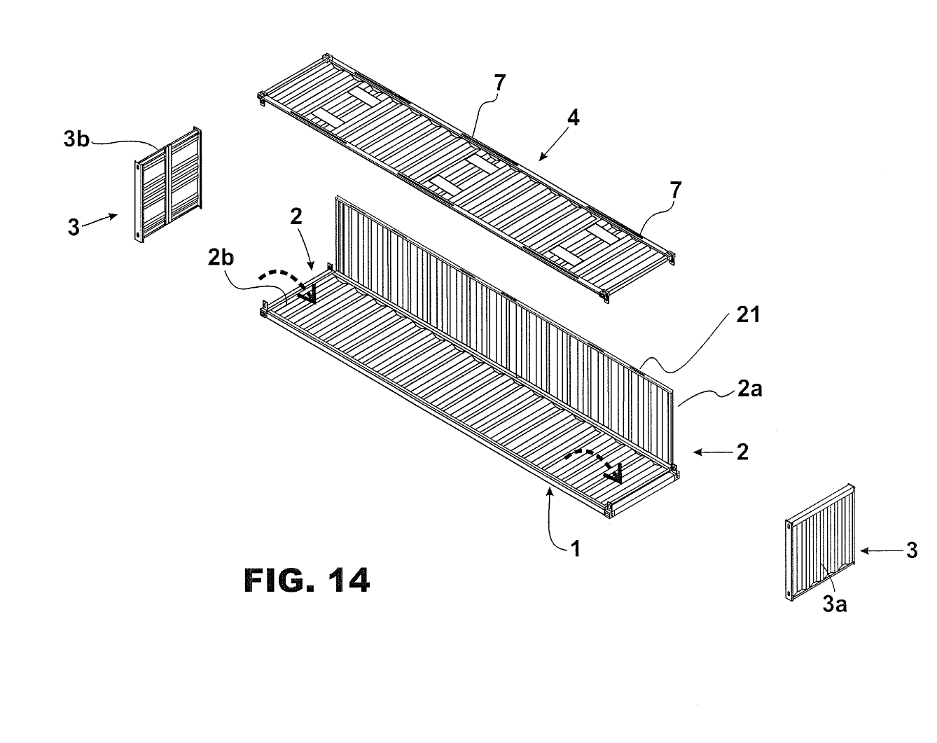

Similarly, the second side wall (2b) may be lowered until it overlaps the side wall (2a). The presence of the lowering compensator (26) allows both side walls (2a) (2b) to overlap in a parallel manner (See FIGS. 14 and 15).

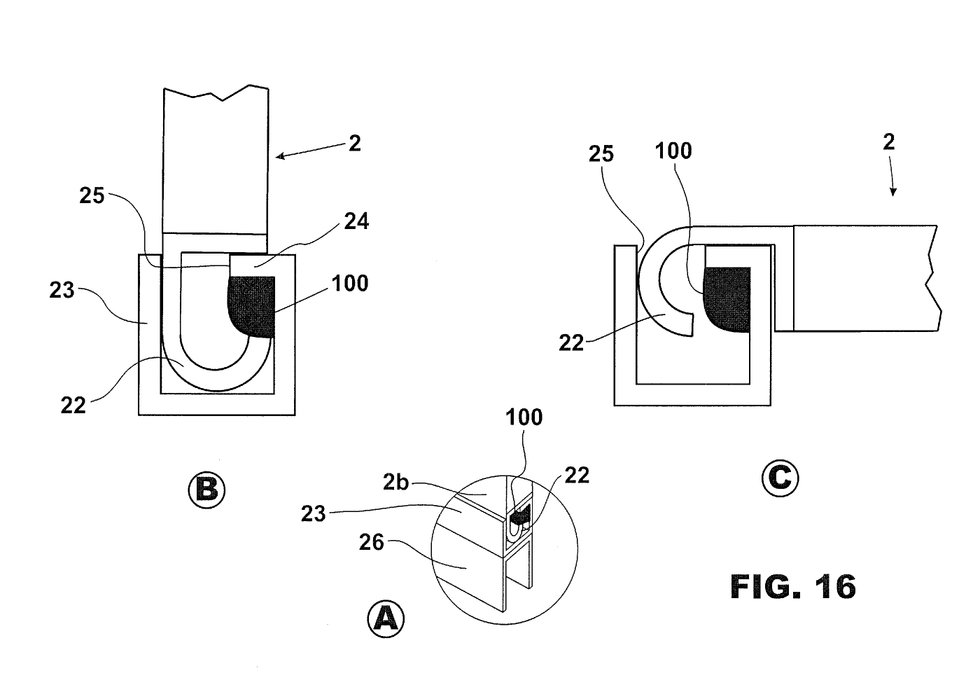

Over the above mentioned lowered second side wall (2b), the head walls are placed (3). The free edges of the columns (30) (31) fit into the space formed between the articulations and the longitudinal edges (21) of the base wall (1) (See FIG. 17).

In an embodiment the columns (30) on one side are narrower than the columns (31) on the other side. This difference in width compensates for the presence of the lowering compensator (22) and therefore, the head walls (3) may overlap and remain parallel to the side walls (2).

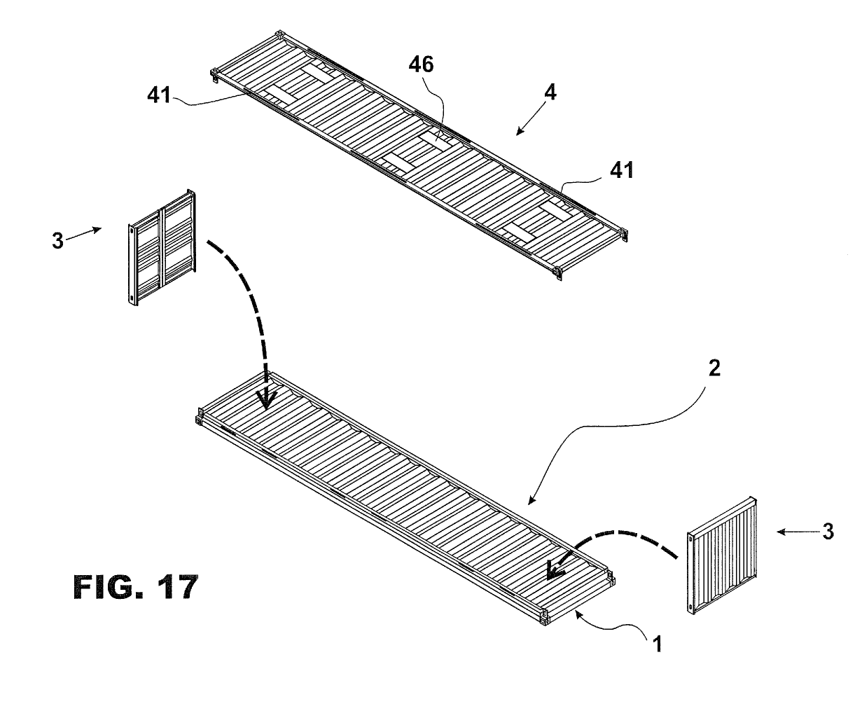

To avoid the undesired movement of the head walls (3), they remain immobile between the lower lock members (51) and some travel stops (53) situated on the longitudinal edges of the base wall (1) (See FIG. 18).

Finally, the top wall overlaps (4). As the lower lock members (52) are misaligned with respect to the lower lock members (51), the lower lock members (52) (51) are arranged one by the other with their corresponding aligned lock passages (51a) (52a) (See FIG. 23B). Through the latter (51a) (52a), the forced wedging side locks (6) are wedged, and thus, the flat structure are formed.

For the assembly, the inverse process is carried out, removing the forced wedging locks (6), raising the top wall (4), removing and standing up the head walls (3), lifting the side walls (2), locking with the head walls (3) and placing the top wall (4) with the corresponding side locks (6) and upper forced wedging locks (7).

Embodiments of the present invention also include methods of disassembly and assembly of present container which comprise a series of stages, in which, for the disassembly, the top wall (4) and the head walls (3) are disassembled, the side walls are lowered (2) on the base wall (1) and the top wall is overlapped (4), forming a flat structure. For the assembly, the top wall (4) is removed, the side walls (2) are raised, the head walls are mounted (3) and the top wall structure (4) is mounted, thus assembling the container.

Referring to FIG. 9, in an embodiment of the present invention, for container disassembly, initially, the upper longitudinal locks (7) and the side locks (6) of the upper part are removed, disconnecting the means (7) (70) (75) (76) that connect the top wall (4) and to the side walls (2), and disconnecting the means (52) (33) that relate said top wall (4) to the head walls (3). Then, the top wall (4) is removed. For this purpose, the hanging supports (46) may be used, as well as the upper openings (50) of the structural corners (5), thus avoiding deformation.

Referring to FIG. 12, the side locks (6) situated in the lower part are then removed, and the side connections (8) that connect the head walls (2) and side walls (3) to each other, are disconnected. Then, the head walls (3) are removed in order to release the space for lowering the side walls (2).

Referring to FIGS. 14 and 15, the first side wall is then lowered (2a) on the base wall (1) and, afterwards, the second side wall (2b) on the first (2a), until both side walls (2) overlap on the base wall (1).

Referring to FIGS. 17 and 18, the head walls (3) are then placed on the previously lowered second side wall (2b), so that the head walls (3) fit between the lower lock members (51) and the travel stops (53), and in a manner such that the edges of the narrowest columns (30) are disposed on the lowering compensator (22).

In an embodiment, accessory devices or structures mounted on the head walls (3) [for example, freezing equipment, ancillary equipment, etc.] are removed and separately stored so that they do not form part of the flat structure.

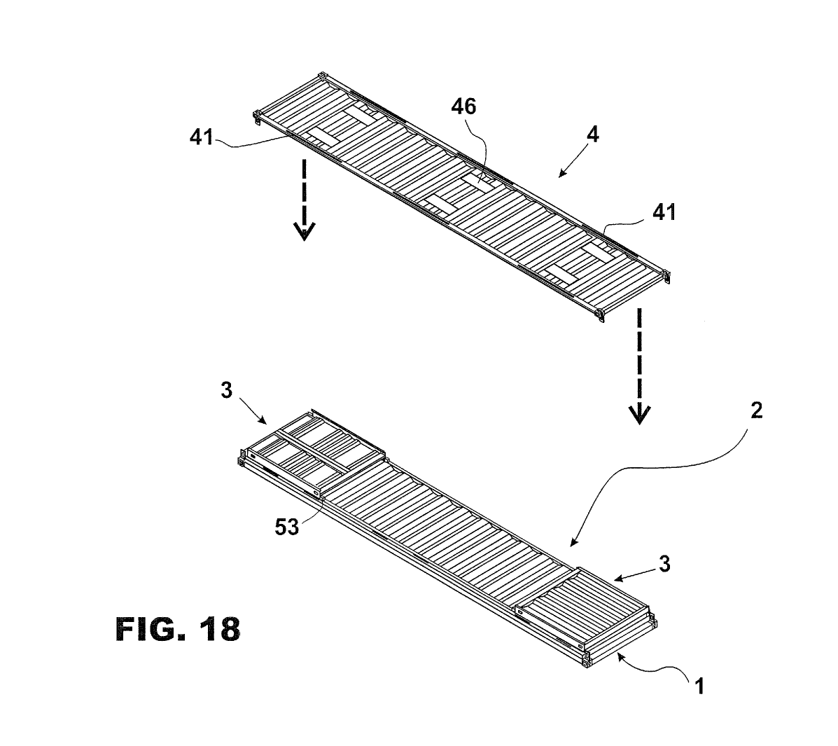

Referring to FIG. 19, the top wall (4) is situated over the base wall (1) so that the entire set overlaps and forms a flat structure. The side locks (6) and/or an alternative connection means can then be placed through lock passages (51a) (52a).

In an embodiment of the present invention, for container assembly, first, the locks (6) are released and the means (51) (52) that connect the top wall (4) with the base wall (1) are disconnected.

Then, the top wall (4) is lifted up to a height above the side walls (2) and head walls (3).

After that, the head walls (3) are removed—or, if they had been stored separately, they are brought in—and then, the side walls (2) are raised until they stay upright. Then, the head walls (3) are raised until they also stay upright. Side connections (8) are connected to the side walls (2), and, the lower inlets (32) and lower lock members (51) are used to connect to the base wall (1).

Finally, the top wall (4) is mounted and all the locks and/or the necessary means (6) (7) (8) are placed to keep the structure upright and assembled.

Undoubtedly, upon putting the present invention into practice, modifications may be introduced regarding certain construction details and form, without leaving the essential principles that are clearly explained in the claims below:

What is claimed is:

1. A collapsible shipping container having a structure that is reversibly collapsible or foldable until forming a flat structure of overlapping walls, comprising:
a base wall, side walls and a top wall, wherein the base wall, the side walls and the top wall are connected at their respective edges and corners so as to form a container housing;
locks connecting the base wall, the side walls and the top wall to each other, the shipping container being at least partially collapsible upon removal of the locks,
wherein the locks comprise forced wedging longitudinal locks that connect the top wall with the side walls,
wherein the forced wedging longitudinal locks act in forced wedging passages that go through the adjacent edges of the top and the side walls, and
wherein the forced wedging passages extends between a wedging opening and a wedge-removing opening.

2. The collapsible shipping container according to claim 1, wherein at least one of the side walls and the top wall comprise a plate wall having a plurality of wave passages that comprise a projecting half-wave and a recessing half-wave.

3. The collapsible shipping container according to claim 1, wherein:
adjacent edges of the top and side walls are connected to each other using the forced wedging longitudinal locks, and the forced wedging longitudinal locks are arranged in the longitudinal sense of the adjacent edges,
insertion pieces are housed within the adjacent edges of the top and side walls and define the forced wedging passages, and the forced wedging longitudinal locks comprise cuneiform members that pass through the forced wedging passages defined by the insertion pieces so as to lock the top and side walls.

4. The collapsible shipping container according to claim 1, wherein:
the wedging opening is configured to receive a forced wedging longitudinal lock, and the wedging opening is in the upper part of the adjacent edge of the top wall, and
the wedge-removing opening through which a forced wedging longitudinal lock is removed is on the outer side of the adjacent edge of the side wall.

5. The collapsible shipping container according to claim 3, wherein for an individual forced wedging passage, a single insertion piece is housed within the adjacent edges of the top and side walls to define the individual forced wedging passage.

6. The collapsible shipping container according to claim 3, wherein for an individual forced wedging passage, a set of insertion pieces is housed within the adjacent edges of the top and side walls to define the individual forced wedging passage.

7. The collapsible shipping container according to claim 1, wherein one or more of the forced wedging longitudinal locks comprises elastic positional locks.

8. The collapsible shipping container according to claim 2, wherein a forced wedging passage comprises a wedging opening in the edge of the top wall and as many wedge-removing openings as there are recessing half-waves of the side wall that are encompassed by the forced wedging passage.

9. The collapsible shipping container according to claim 1, wherein the side walls include head walls and major walls, and the locks further comprise forced wedging side locks that connect the head walls with the top and major walls, wherein the forced wedging side locks have a cuneiform structure and comprise a material susceptible to magnetic induction.

10. The collapsible shipping container, according to claim 1, wherein the top wall comprises hanging supports distributed across the length and breadth of the top wall.

11. The collapsible shipping container, according to claim 10, wherein:
the top wall comprises a plate wall having a plurality of wave passages that comprise a projecting half-wave and a recessing half-wave, and
the hanging supports of the top wall comprise members that are fixed to the top wall and extend between two adjacent projecting half-waves.

12. The collapsible shipping container according to claim 4, wherein the wedging opening comprises a retention lock that keeps the forced wedging longitudinal lock into the forced wedging passage.

13. The collapsible shipping container according to claim 12, wherein the forced wedging longitudinal lock comprises a guide stop in which the retention lock fits.

14. The collapsible shipping container according to claim 1, further comprising an upper longitudinal waterproof insulator arranged between the top and side walls and inserted between the forced wedging longitudinal locks and the container housing.

15. The collapsible shipping container according to claim 1, wherein:
the upper longitudinal edge of the major side walls connect to the top wall using the forced wedging longitudinal locks,
the lower longitudinal edge of the major side walls connect to the base wall using articulations formed by an opening bend of the lower longitudinal edge, the opening bend being turned within an open casing provided by the base wall.

16. The collapsible shipping container according to claim 15, further comprising a lower longitudinal waterproof insulator arranged within the open casing of the base wall such that the open bend of the side wall turns until the open bend contacts the lower longitudinal waterproof insulator whereby the side wall is upright.

17. A collapsible shipping container comprising:
a base wall, side walls and a top wall, wherein the base wall, the side walls and the top wall are connected at their respective edges and corners so as to form a container housing, wherein
at least one of the side walls and the top wall comprise a plate wall having a plurality of wave passages that comprise a projecting half-wave and a recessing half-wave;
locks connecting the base wall, the side walls and the top wall to each other, the shipping container being at least partially collapsible upon removal of the locks,
wherein the locks comprise forced wedging longitudinal locks that connect the top wall with the side walls;
insertion pieces housed within the adjacent edges of the top and side walls and which define forced wedging passages, wherein the forced wedging longitudinal locks comprise cuneiform members that pass through the forced wedging passages defined by the insertion pieces so as to lock the top and side walls,
wherein one or more of the forced wedging longitudinal locks comprises elastic positional locks,
wherein at least one forced wedging passage of the forced wedging passages comprises a wedging opening in the edge of the top wall and as many wedge-removing openings as there are recessing half-waves of a side wall that are encompassed by the forced wedging passage,
wherein the wedging opening comprises a retention lock that keeps the forced wedging longitudinal lock into the forced wedging passage.

18. A method of disassembly and assembly of the container of claim 1, comprising:
releasing upper locks that connect the top wall with major side walls by wedge-removing the upper locks through wedge-removing openings of the upper locks, wherein the major side walls are a set of walls from among the side walls;
releasing upper head locks that connect head side walls with the top wall by wedge-removing the upper head locks, wherein the head size walls are a set of walls from among the side walls;
disassembling the top wall;
releasing lower head locks that connect the head walls to the base wall by wedge-removing the lower head locks;
disassembling the head side walls;
lowering the major side walls, one at a time, until the main side walls overlap on the base wall;
overlapping the head side walls and the top wall over the major side walls such that the base wall, major side walls, head side walls, and top wall overlap and forming a flat structure;
locking the flat structure in place by connecting the top wall to the base wall;
releasing the connection of the top wall to the base wall;
raising the top wall to a height above the height of the major or head side walls;
removing the head side walls;
Raising the major side walls until upright;
mounting the head side walls until upright on the base wall and connecting the head side walls with the base wall and major side walls,
mounting the top wall and locking the structure in place using the locks.

19. The method according to claim 18, wherein for mounting and dismounting the top wall, a lifting means is anchored to hanging supports distributed across the length and breadth of the top wall.

20. The method according to claim 17, wherein a magnetic device is used to remove the upper and lower head locks.
